(19) United States
(12) Patent Application Publication
(10) Pub. No.: US 2022/0114185 A1
(43) Pub. Date: Apr. 14, 2022

(54) SOCIAL MEDIA PLATFORM

(71) Applicant: Marco Antonio CASTRO, El Paso, TX (US)

(72) Inventor: Marco Antonio CASTRO, El Paso, TX (US)

(21) Appl. No.: 17/500,130

(22) Filed: Oct. 13, 2021

Related U.S. Application Data
(60) Provisional application No. 63/090,894, filed on Oct. 13, 2020.

(51) Int. Cl. G06F 16/2457; G06F 21/62; G06Q 50/18; G06Q 50/00

(52) U.S. Cl. CPC G06F 16/24575; G06Q 50/01; G06Q 50/186; G06F 21/6245

(57) ABSTRACT

According to at least one exemplary embodiment, a method, system and computer program product for an online social media platform may be shown and described. The platform may provide a service for creating and securing content. The content may be created by a user. In an exemplary embodiment, the content may be released upon or after the death of the user. In an exemplary embodiment, the content may be the user's last will, memories, sentiments, or some words for living survivors, groups, or the general public. Users may publicly leave user content or a video, or may designate the content to only be accessible privately to a selected group of people. An ancestry log or family tree may be formed from the stored content. The ancestry log may be publicly viewable, or viewing may be restricted to relatives or other designated recipients.

### CROSS-REFERENCE TO RELATED APPLICATIONS

The present patent application claims benefit and priority to U.S. Provisional Patent Application No. 63/090,894 entitled “SOCIAL MEDIA PLATFORM” filed on Oct. 13, 2020, which is hereby incorporated by reference into the present disclosure.

### FIELD

An exemplary embodiment relates to the field of online social media.

### BACKGROUND

Social media platforms allow families, friends, and acquaintances to connect or re-connect at any time or location. Typical social media platforms allow a user to post content for their friends or followers. In some instances, the content can be seen publicly by anyone who obtains the link, such as friends of friends or friends who have not been specifically selected for viewing (such as by adding them to a “friends list”). Content can be tailored to specific groups of people, such as close friends, followers, or a subset of followers. However, any of these features must be selected by the user as the post is being created and posted. Current social media platforms do not provide an option to create content that is posted at a later point in time.

### SUMMARY

According to at least one exemplary embodiment, a method, system and computer program product for an online social media platform may be shown and described. The platform may provide a service for creating, securing, and distributing user content. The content may be created by a user on the platform, or may be created externally and uploaded to and stored on the platform. The content may be stored in a secure database or in a blockchain. In an exemplary embodiment, the content may be released upon or after a specified time, an event, or the death of the user to a designated viewer, set of viewers, or audience. In an exemplary embodiment, the content may include instructions and legal documents such as the deceased user's will and testament, as well as content such as some words for living survivors, groups, or the general public. The user content may be presented on a user's profile. Once published, the user content may be accessed via an online platform. The platform may publish and present content from multiple users. Content from users can be organized based on geographic location, date of posting, or based on text within the content (such as, for example, a hashtag, title, or label).

The platform may provide a registration module for registering user accounts. Account information may be provided by a user to the registration module, which may issue an account to identify each user. For example, each user may be identified using some unique identifier. It may be contemplated that the user's identity may be verified by, for example, confirming the user's Social Security number, driver's license number or information, or using any other identifier or identifying document. Each user account may be associated with a unique set of preferences configurable by each user. The preferences may include information such as procedures and rules for publishing the user's content. For example, the user may specify when to publish the content, such as on a specific date, after the occurrence of an event, or after the death of the user. The user may also specify the recipients of the content, a duration of the publication, or the method for confirming the event. Content may be published on the platform, which may allow users to search and browse through the published content. For example, the content may provide users with an emotional support system. Users may communicate with and comfort one another using the platform and by commenting on or posting content. It may be contemplated that published content may be integrated into another system, such as a searchable ancestry or familial video archive. The ancestry archive may include content posted by the users, and may be grouped according to familial relations between users.

If the content is to be published only after the death of the user, an exemplary embodiment may confirm the death of a user in a number of ways. For example, the user may specify one or more trusted contacts which can notify the system. Alternatively, an exemplary embodiment may search or connect with an external database containing death information. The user may enter identifying information, such as a date of birth or social security number, and the system may continuously monitor or periodically search the external database for confirmation of a death corresponding to the user's identifying information.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a schematic flowchart illustrating a method for providing a social media platform.

FIG. 2 is an exemplary embodiment of a site map schematic flowchart for an exemplary social media platform.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

An exemplary embodiment may provide a social media platform. The platform may allow users to create and store content in a secure database or in a blockchain. The content may be released at a specified time or date, and may be inaccessible until then. Alternatively, the content may be released after or upon the occurrence of an event. For example, the content may be set to be released upon the death of a user or a person whom the content is tailored to.

An exemplary embodiment may receive information or a notification regarding the death of a user in a number of ways. For example, an exemplary embodiment may be connected to a database which provides death information. Further, an embodiment may allow certain people duly authorized by the user to provide the notification of the user's death, thereby releasing the content. In another embodiment, the content may be scheduled for release if the user does not interact with the platform or some other notification for a certain period of time. Any other notification means may be contemplated.

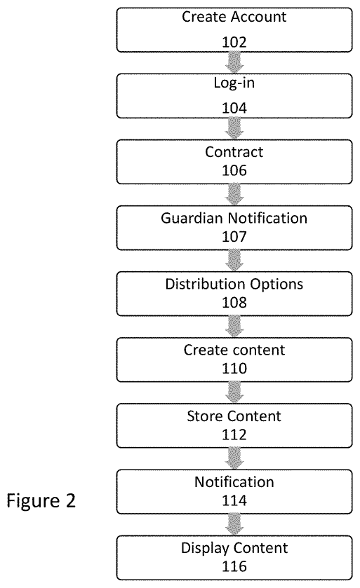

Referring now to exemplary FIG. 2, FIG. 2 may illustrate a schematic flowchart of a method for providing an exemplary embodiment. First, a user account may be created 102. The account creation may include receiving information about the user such as name, date of birth, email address, and other identifying information. Next, the user may login to the created account 104 in order to interact with other portions of the system. In an exemplary embodiment, the user may create a personalized contract 106 with the service which may include options for the creation, storage, and distribution of content. The contract may also include legal documents and may be a legal contract or will. In an exemplary embodiment, the guardian may then be selected and/or notified 107. Other options may then be selected 108 to define how the content is eventually distributed.

The content may be created by the user and uploaded to the platform 110. It may be contemplated that the content may be created on the platform by the user, or may be created outside of the platform and then uploaded. In one example, the content may be a video which states the user's final wishes, memories, sentiments, or “last whisper.” A fee may be required for the content to be stored and/or published. The content may be stored on the platform, such as on a cloud server or blockchain 112. At some point after the upload, it may be contemplated that the user passes away, at which point the platform may receive a notification validating the user's death 114.

The death notification may be provided to the platform via a number of ways. For example, the notification may be received from a database, such as a Social Security or equivalent government database, which is continuously updated with the deaths of individuals. The platform may regularly check the database for new names and then may cross-reference the database with a list of users in order to check if any users have passed away. In the event that a user has died, the platform may publish or distribute the content 116. The distribution may depend on the user's selected options. For example, some users may opt to publish their content for the general public, whereas other users may prefer to only send the content to a specific group of people. It may be contemplated that a user can select or create content to be sent to different groups of people, such as an organization, employer, religious forum, funeral service, and the like. In some embodiments, the user may select an audience for the content to be published to, such as to the media, news outlets, fan groups, a group of social media followers, and the like. The content may be stored on the platform for a period of time after the death of the user. In an exemplary embodiment, videos may be stored indefinitely and used to create a video registry serving as an ancestry memorial or ancestry database, which may be made available internally or may be on an external platform.

Another exemplary embodiment may provide an ancestry database. After publication or release of the content, some content may be published to an external platform, such as an ancestry database which may include historical content relating to past users and past user content. The ancestry database may be grouped according to familial relationships, allowing a user to quickly identify ancestors and other relatives as well as the content uploaded by the relatives. The ancestry database may provide a time capsule system which allows a user to upload a video or other content which is to be opened after a certain number of years.

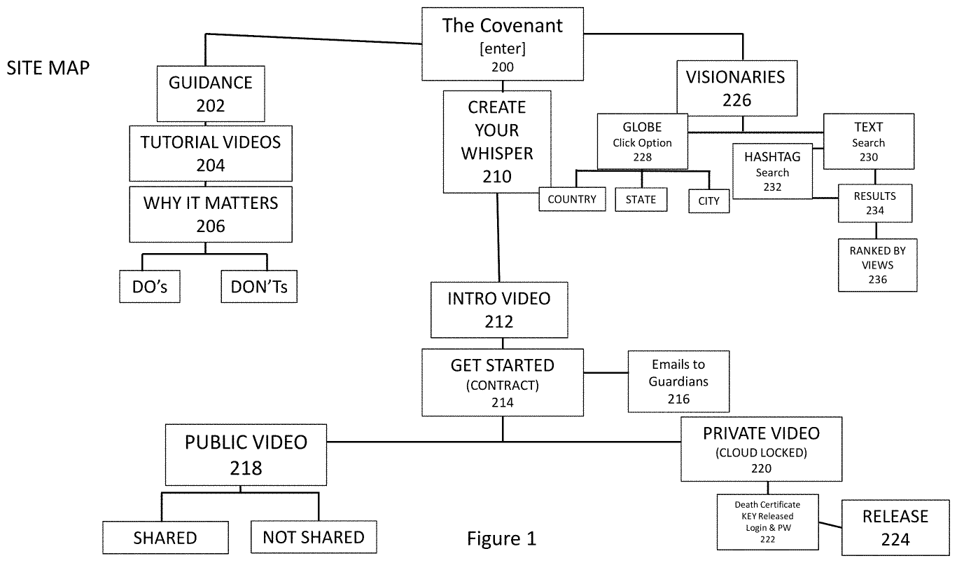

Referring now to the exemplary embodiment in FIG. 1, FIG. 1 may illustrate an exemplary site map schematic flowchart. First, a user may navigate to the site 200. In an exemplary embodiment, the user may choose between three categories: guidance 202, creation 210, and visionaries 226. The guidance section 202 may include tutorial videos 204 as well as other helpful information, for example, including information regarding the importance of a last will and testament 206. In an exemplary embodiment, the guidance section may include useful tips or guidance for creating content.

The creation section 210 may be used to create content to be published or distributed. For example, an intro video 212 may be created by the user in this section. The user may also formulate a contract 214 to specify details regarding the distribution and storage of the content. Optionally, an email may be sent to guardians, relatives, or friends of the user 216. The user may create or upload public and/or private content. Public content or public videos 218 can be shared or stored. Private content 220 may be held until the notification or death certificate of the user is received 222. After the notification and validation of death, the private content may then be released 224 as specified in the contract 214.

In an exemplary embodiment, users may explore content created by other users. Each piece of user content or each user's content may be identified based on an identifier assigned to the user. The identifier may delineate surnames tagged in social media posts or surnames identified by the platform. For example, the identifier may include the first initial and last name of the person whom the content is directed towards. The unique identifier may take the form of a hashtag and may further include a categorical symbol, for example, indicating whether the content is publicly accessible or whether the content is hidden from the public. An exemplary identifier may thus comprise a hashtag symbol, the categorical symbol, the first initial, and the last name (e.g., #COVMCASTRO, where COV is the categorical symbol indicating that the content is hidden and privately stored, ‘M’ is the first initial, and ‘CASTRO’ is the last name). It may be contemplated that categorical symbols may include ‘COV’, which indicates that user content is hidden or private, and NIS', indicating that the user content is publicly accessible for viewing.

An exemplary embodiment may provide a “visionaries” section 226. Users from around the world may upload their content and, if they allow it to be viewed publicly, it may be viewed by any other users. Users may search and/or filter through the public posts. For example, it may be contemplated that content is filtered based on location 228, such as by searching for posts from a specific country, state, or city. Alternatively, a text search may be contemplated 230. The text search may include searching by a specific hashtag 232, or may alternatively or additionally search the text of the content. The results 234 may be presented to the user, for example, as a list. In an exemplary embodiment, the results may be ranked by the number views, likes, or other positive feedback they have received 236, allowing users to quickly identify popular content. Users may be ranked according to feedback, likes, or views attributed to their content, and may compete with one another to increase their ranking. For example, a top ranked user may be designated a special status, such as, for example, a ‘top visionary’ status.

It may be contemplated that the content uploaded by a user may be related to that user's life or experiences. Alternatively, a user may create content directed at another person. For example, the user may opt to create a video in response to the death of another user, relative, friend, acquaintance, role model, celebrity, or any other contemplated person.

An exemplary embodiment may implement long-term storage solutions, since content may be stored for a long period of time before being released. Further, content may be designated as personal or public. Personal content may be specifically designated to be distributed to specific people who have secure access to the content, such as for individual friends and family. Public content may be viewable by anybody. In an exemplary embodiment, public content may be published to one or more social media platforms or personal websites. Public content may also be searchable and viewable on an exemplary embodiment, such as in the visionaries section 226.

An exemplary embodiment may implement a visionary reward system. The visionary reward system may identify positive feedback from the user content, such as a number of likes associated with that user's content. The positive feedback metric may be aggregated from all the content uploaded by the user, an average positive feedback associated with each user content uploaded by the user, or may be based on the positive feedback on one form of content associated with the user. If a user receives a predetermined amount of positive feedback, such as a specified number of likes, they may be rewarded. The reward may be, for example, the ability to post additional content or longer videos. In an exemplary embodiment, user content in the form of videos may be limited to a certain amount of time, such as 60 seconds each. The amount of time per video may vary according to user, based on the user's positive feedback. It may be contemplated that the amount of time may be increased up to a predetermined maximum time constraint.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for aggregating user content and presenting the user content upon satisfying one or more conditions implemented on a non-transitory computer readable memory, comprising executing on a processor the steps of:
receiving account information from a user, the account information comprising at least identification information corresponding to the user;
storing the content uploaded by the user in a secure database, querying the user for user input for one or more content preferences, and updating the content preferences based on the user input;
wherein content stored in the secure database is not accessible for viewing;
monitoring or continuously searching one or more databases for one or more death confirmations associated with one or more deceased users from the plurality of users;
publishing, to a platform, the content uploaded by the deceased users after identifying the death confirmations corresponding to the deceased users.

2. The method of claim 1, further comprising:
receiving additional content and storing the additional content in the database.

3. The method of claim 1, wherein the identification information comprises at least a name, date of birth, and an identifier unique to the user.

4. The method of claim 3, wherein the identifier unique to the user is a Social Security number, and wherein the method further comprises:
constantly monitoring and searching an external database for the Social Security number of the user, and confirming the death of the user by locating the Social Security number on the external database.

5. The method of claim 1, wherein the content preferences comprise a list of intended recipients, a publication time after death, and a public access level.

6. The method of claim 1, wherein the user content comprises a video created by the user.

7. The method of claim 1, wherein the user content comprises a legal document taking effect after the death of the user.

8. The method of claim 1, wherein the user content is stored on a cloud or in a blockchain and accessible only to the user until the death of user.

9. A system for aggregating user content and presenting the user content upon satisfying one or more conditions, the system comprising a processor and memory configured to execute the steps of:
receiving account information from a plurality of users, the account information comprising at least identification information and content preferences corresponding to each user;
storing the user content uploaded by the users in a secure database, wherein the content in the secure database is only accessible to an uploader of the content;
monitoring or continuously searching one or more databases for one or more death confirmations associated with one or more deceased users from the plurality of users;
publishing, to a platform, the content uploaded by the deceased users after identifying the death confirmations corresponding to the deceased users.

10. The system of claim 9, further comprising:
identifying a location associated with a plurality of location-tracked users from the plurality of users, associating the corresponding user content with the location, and presenting the user content based on the location of the location-tracked users.

11. The system of claim 1, further comprising an ancestry log, wherein user content is uploaded to the ancestry log and organized based on one or more familial relationships between users.

12. The system of claim 9, wherein the platform is publicly accessible.

13. The system of claim 9, wherein the platform is only accessible to one or more recipients identified by the user in the content preferences.

14. The system of claim 9, further comprising removing the published user content after a predetermined period of time.

15. A non-transitory computer-readable medium for aggregating user content and presenting the user content upon satisfying one or more conditions, containing program code comprising:
an account module configured to receive and store account information corresponding to a plurality of users;
a death notification module configured to receive a confirmation that one or more users have died;
a storage module configured to securely store user content uploaded by the plurality of users, wherein the user content in the storage module is encrypted and private to each user;
a publishing module configured to receive the confirmation from the death notification module, associate the confirmation with account information, apply a plurality of content publishing preferences predetermined by the user, and publish the user content according to the content publishing preferences;
a browsing module configured to display, from the publishing module, the user content corresponding to one or more users; and
a creation module accessible to the users configured to receive information and/or content from the user to form or alter the user content.

16. The non-transitory computer readable medium of claim 15, wherein after the publishing module publishes the user content, the system is further configured to send an electronic message to one or more clients comprising the published user content and/or a link to the published user content.

17. The non-transitory computer readable medium of claim 15, wherein the creation module further comprises a plurality of tutorial videos and instructions for creating user content.

18. The non-transitory computer readable medium of claim 15, wherein the creation module is configured to create, based on user input, a will.

19. The non-transitory computer readable medium of claim 15, wherein the creation module is configured to create a video.

20. The non-transitory computer readable medium of claim 15, wherein the browsing module is configured to display user content from the publishing module based on location of the user or based on text within the user content.
